(19) United States
(12) Patent Application Publication
(10) Pub. No.: US 2013/0162398 A1
(43) Pub. Date: Jun. 27, 2013

(54) ELECTRONIC ASSISTANCE CALL DEVICE, SYSTEM AND METHOD OF USING SAME

(71) Applicant: Petra Stoick, Elkhorn, WI (US)

(72) Inventor: Petra Stoick, Elkhorn, WI (US)

(21) Appl. No.: 13/723,349

(22) Filed: Dec. 21, 2012

Related U.S. Application Data
(60) Provisional application No. 61/579,386, filed on Dec. 22, 2011.

(51) Int. Cl. G08B 1/08

(52) U.S. Cl. 340/7.58

(57) ABSTRACT

An electronic assistance call device, system and method provide a transmitter portion and a receiver portion. The transmitter portion is wearable and activated by a first person. The receiver is wearable by a second person. Upon activation of the transmitter, a signal is sent from the transmitter directly to the receiver portion. The receiver portion, in turn, provides the second person with an alert via the receiver, which can be by a tactile vibration, a sound and a light, or any combination of such modalities. Each portion is self-contained and carries an electrical energy source, such as a battery, and electrical circuitry that extends the useful life of the energy source. The device portions can be used in a “sleep” mode and activated to a “use” mode. At all other times, the device portions would remain in the sleep mode, thereby preserving the electrical energy of the self-contained supply source.

### SPECIFICATION

This Application claims the benefit of U.S. Provisional Application No. 61/579,386, filed Dec. 22, 2011.

### FIELD OF THE INVENTION

The present invention relates generally to pagers, transmitters, receivers and transceivers that use wireless technology to signal or detect a situation or condition. More particularly, it relates to an electronic assistance call device and system, as well as the methodology, that use wireless technology to allow a first person to actuate a first tag, which first tag is in direct wireless contact with a second tag of a second person to inform the second person of the first person's need for assistance. Noteworthy is the fact that the device, system and method do not use a centralized routing system to respond to the wireless signal generated by the first tag or to activate the second tag, the second tag using light, sound and/or tactile vibration to alert the second person that the first person has actuated the first tag and is in need of assistance.

### BACKGROUND OF THE INVENTION

In the area of data acquisition and the processing of that acquired data, the use of wireless communication devices is well known. For example, infrared technology and radio frequency identification (RFID) technology, in particular, are well known in the art of wireless communication devices and in the art of electronic identification methods. RFID technology relies on the storage and remote retrieval of data by means of one or more transmission or transponder devices that are frequently called RFID “tags.” An RFID tag is a small electronic device that can be attached to or incorporated within a physical item or object for a number of different purposes. RFID tags contain micro-circuitry and antennas that enable them to receive and respond to radio frequency queries from an RFID transceiver. Passive tags require no internal power source, whereas active tags typically require a power source.

It is also recognized that wireless communication devices may include other types of communication technologies other than RFID. For example, certain wireless and cellular phone technologies may be combined with a wireless network and include devices such as pagers, cell phones, Blackberry® devices, personal digital assistants (PDA), tablet computers, Bluetooth® headsets, desktop personal computers (PCs), laptop computers, kiosks, slate computers and dumb terminals. Each of these technologies, and its ability to operate in the context of the device, system and method of the present invention, is proven to be effective wireless technology. These technologies are mature and capable of storing, processing and providing reporting at the level of granularity required in accordance with the present invention. It is to be understood, however, that to the extent that a centralized system or centralized location is not used such other wireless communication devices and other wireless communication methodologies are included within the scope of the present invention. All of such technologies will be collectively referred to in this application as “RFID technology” which generates or receives an “RFID signal,” or simply “RFID.”

Medical alert systems are also well known. Such systems typically provide a patient, or several of them, with a device that can be worn, carried by the patient or placed within close proximity to the patient to transmit an alert signal to a centralized location. Upon receipt of such signal at the centralized location, a medical assistant can be dispatched to the patient's home or facility to assist the patient with the condition or situation that triggered his or her need for assistance. In the area of centralized medical alert systems, an alarm condition that is signaled by the patient is transmitted to a transceiver that, in turn, retransmits the signal to a centralized location which, quite typically, is not in close proximity to the patient. Indeed, the “centralized” location is purposely intended to be capable of servicing a large geographic area which means that it will, of necessity, be remote from the location of most patients. Once the signal is received at the centralized location, a medical unit or paramedical staff is dispatched to the patient's location for the purpose of attending to the patient and/or transporting the patient to a facility where more critical care can be provided. That is, the recipient of the medical alert typically is not the person who actually delivers the care to the patient. That care is almost always delivered by another person, or persons, who have received the medical alert indirectly from the original receiver or a dispatcher, not from the patient himself or herself.

In the view of this inventor, there is a need to devise an assistance call device that provides direct contact from the patient to the responder and that does not require a centralized medical alert system. Instead, the device would be activated by a first person to contact a second person who may be in relatively close proximity to the first person, such as in the same house or even in a nearby house, such that the second person may quickly respond to the first person's call. There is a need to fabricate such a device and system that can comprise both a transmitter portion and a receiver portion such that a wireless signal can be transmitted by the transmitter portion and such that the same wireless signal can be received by the receiver portion directly from the transmitter portion, and without routing the signal via a centralized system. Within the scope of the present invention is the concept whereby the transmitter portion is configured for signal transmission only and whereby the receiver portion is configured for signal reception only. This concept would greatly simplify the device, system and methodology and could “pair” or synchronize the transmitter portion with the receiver portion.

In accordance with the present invention, the first person would experience a medical alert condition. The first person would then activate the transmitter portion, thereby transmitting a signal, and the second person would be alerted via the receiver portion, the receiver portion being configured for receiving the transmitted signal directly from the transmitter portion. There is also a need to make such a device that is convenient to wear, much like a wrist watch or a pendant, and easy to use. There is also a need to make such a device that provides a receiver portion that can alert the second person, or assistant, via one or more of several different modalities, such as by sound, light or vibration, or any combination of those modes. It would be desirable to provide for different sounds and sound volumes as well as different light arrays, both of which would quickly alert the second person that his or her receiver has been activated. In their portability, the transmitter portion and the receiver portion must each be capable of carrying a self-contained electrical energy source, such as a battery. There is also a need to make such device portions long lasting so that the life of the self-contained energy source is usable for an extended period of time prior to battery replacement. To insure sustained battery life and functionality, there is also a need for the device portions to be used in a “sleep” mode and activated to a use mode as such becomes required or desired. At all other times, the device portions would remain in the sleep mode, thereby preserving the electrical energy of the self-contained supply source.

### SUMMARY OF THE INVENTION

In accordance with the foregoing, it is an object of the present invention to provide an assistance call device that does not require a centralized medical alert system. It is another object of the present invention to provide such a device that can be activated by a first person to contact a second person who would be in relatively close proximity to the first person. In this way, the second person may quickly respond to the first person's call. It is still another object to fabricate such a device and system such that it comprises both a transmitter portion and a receiver portion, the transmitter portion being capable of transmitting a wireless signal and the receiver portion being capable of receiving such signal. It is yet another object to provide such a system whereby the transmitter and receiver portions are each convenient to wear and are configured as either a wrist watch or as a pendant, both of which are discretely worn and easy to use. It is a further object to provide such a system whereby there is a receiver portion that can alert the second person in several different ways, such as by sound, light or vibration, or any combination thereof. It is still another object of the present invention to provide the transmitter portion and the receiver portion with a self-contained electrical energy source, such as a battery, and to provide a means for extending the life of the energy source.

The device of the present invention has obtained these objects. It provides for a transmitter portion and a receiver portion. The transmitter portion of the device can be worn and activated by a first person. The receiver portion is worn by a second person. The respective portions are wearable about the user's wrist or neck, such as with a lanyard, or sat on a night stand in close proximity to the user. Upon activation of the transmitter portion, the receiver portion, in turn, provides the second person with an alert via the receiver directly from the transmitter portion, which can be by a tactile vibration, a sound and a light, or any combination of those alert modalities. Each portion of the device is self-contained and carries an electrical energy source, such as a battery, and electrical circuitry that extends the useful life of the energy source. To insure sustained functionality, each portion of the device can be used in a “sleep” mode and activated to a “use” mode as such becomes required or desired. At all other times, the respective portions of the device would remain in the sleep mode, thereby preserving the electrical energy of the self-contained supply source. As will be apparent from the detailed description that follows, the transmitter portion and the receiver portion may each be broadly defined and referred to also as an “RFID tag” or simply as a “tag.”

The foregoing and other advantages of the electronic assistance call device, system and method of the present invention will be further apparent from the detailed description that follows.

### BRIEF DESCRIPTION OF THE DRAWINGS

FIG. 1 is a schematic diagram illustrating the outfitting of a first person with one of two active RFID tags, each configured in accordance with the present invention.

FIG. 2 is a schematic diagram illustrating the outfitting of a second person with one of two active RFID tags, each configured in accordance with the present invention.

FIG. 3 is a schematic diagram illustrating the transmission of an electronic signal from the wrist-worn tag of the first person to the wrist-worn tag of the second person.

FIG. 4 is a schematic diagram illustrating the transmission of an electronic signal from the neck-worn tag of the first person to the neck-worn tag of the second person.

FIG. 5 is a schematic diagram illustrating the modes of operation that can be actuated in the tags worn by the second person.

FIG. 6 is a schematic flow diagram illustrating the methodology used in the invention of the present invention.

### DETAILED DESCRIPTION

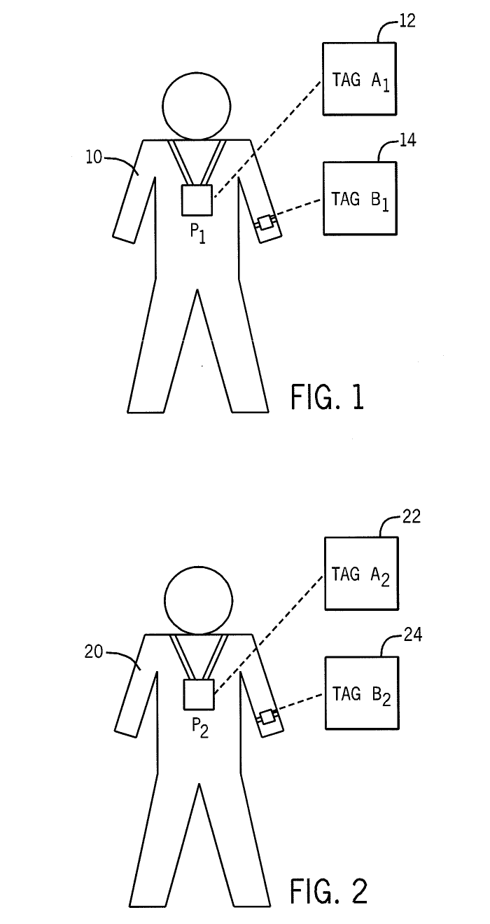

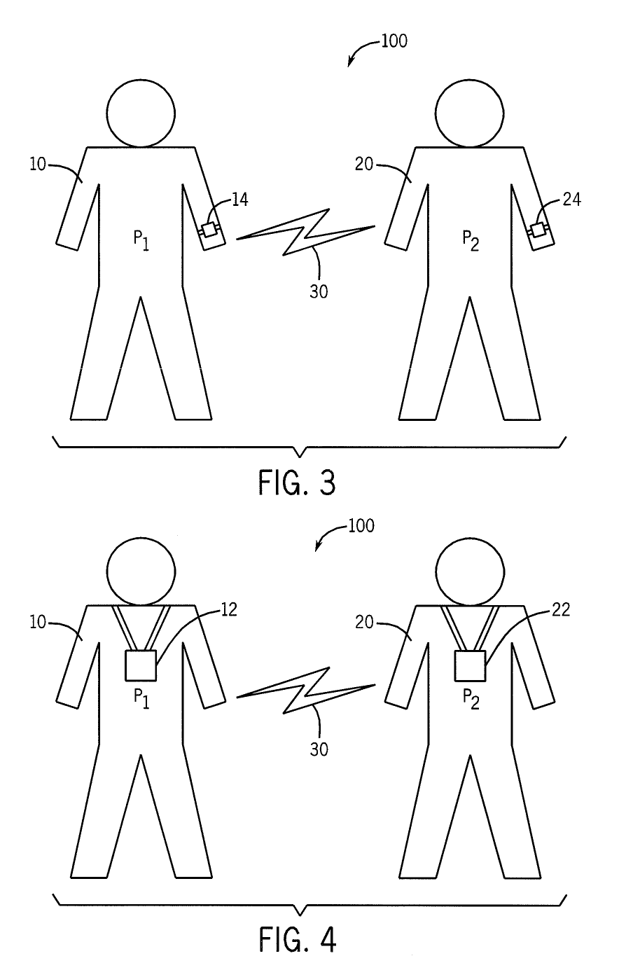

Referring now to the drawings in detail, wherein like numbered elements refer to like elements throughout, FIGS. 1 and 2 illustrate, in schematic form, two persons P₁ (10) and P₂ (20) with whom the device of the present invention can be used. It is to be understood that, although only two persons are shown, the device and system of the present invention is not limited to the two-person application. That is, any number of persons could use the device of the present invention. As shown, the first person (10) is a person outfitted with one of two types of electronically active RFID tags (12, 14) also identified as TAG A₁ and TAG B₁, respectively, that is worn as a pendant about his or her neck or attached to his or her wrist. This first person (10) is typically an individual who may have a medical or other condition for which that person may need assistance from time to time. It is to be understood that the active RFID tags (12, 14) each comprises electronic circuitry and includes a programmable logic controller or “PLC” (not shown) which is part of a “transmitter.” The transmitter is adapted to generate and propagate, by means of an antenna (also not shown), electromagnetic waves of the type that can be generated as a given frequency and received directly from the transmitter portion by a remotely located receiver portion, the receiver also being outfitted with an antenna. See FIGS. 3 and 4. It is to be understood that the active RFID tags (12, 14) could also be configured as infrared tags, or other type of tag that utilizes wireless information technology that has been used or which has yet to be used. The important purpose of the RFID tags (12, 14) is to allow the first person (10) to transmit a wireless signal directly to a second person (20) and for the second person (20) to receive and be alerted by such signal when the signal is received by his or her RFID tags (22, 24). This arrangement does not require the use of a centralized messaging or message transmitting and receiving center of the type that is known in the art. It is also within the scope of the present invention that the RFID tags (12, 14) are transmission-only tags, thus simplifying the circuitry and fabrication of the device.

FIG. 2 shows that the second person (20) is a person outfitted with one of two types of active RFID tags (22, 24) also identified as TAG A₂ and TAG B₂, respectively, that is worn as a pendant about his or her neck attached to his or her wrist. This second person (20) is typically an individual who will or may be in relatively close proximity to the first person (10) such that the second person (20) can attend to the first person (10) who has a medical or other condition for which that person may need assistance. It is to be understood that the active RFID tags (22, 24) of the second person (20) each carries with it certain identifying information and is capable of receiving a wireless signal in accordance with a pre-programmed scheme, including a signal that is transmitted at a pre-determined frequency and is synchronized with the transmitter portion (12, 14) which serves as the “receiver” portion of the device and system of the present invention. Again, the important purpose of the RFID tags (22, 24) worn by the second person (20) is to allow the second person (20) to receive a wireless signal from the first person (10). It is also to be noted that the tags (22, 24) could be detached, as necessary, from the second person (20) such that the tags, or one of them, can be placed in a location that is close to the second person (20). That is, the tags (22, 24) could be configured to be placed on a countertop in a kitchen, a dresser in a bedroom, or some other location within a home and readily accessible to the second person (20). It is also within the scope of the present invention that the RFID tags (22, 24) are reception-only tags, thus simplifying the circuitry and fabrication of the device.

Referring now to FIGS. 3 and 4, they illustrate a system (100) that is configured in accordance with the present invention. The system (100) comprises a wireless signal (30) being transmitted by an RFID tag (12, 14), or transmitter, from the first person (10) and received by an RFID tag (22, 24), or receiver, worn by the second person (20). The signal (30) is synchronized such that the transmission frequency matches the reception frequency. It is to be understood that the type of receiver and transmitter may be varied, i.e. one may be a wrist-attached unit and the other a pendant-style unit. The system (100) of the present invention is not limited to the embodiments illustrated.

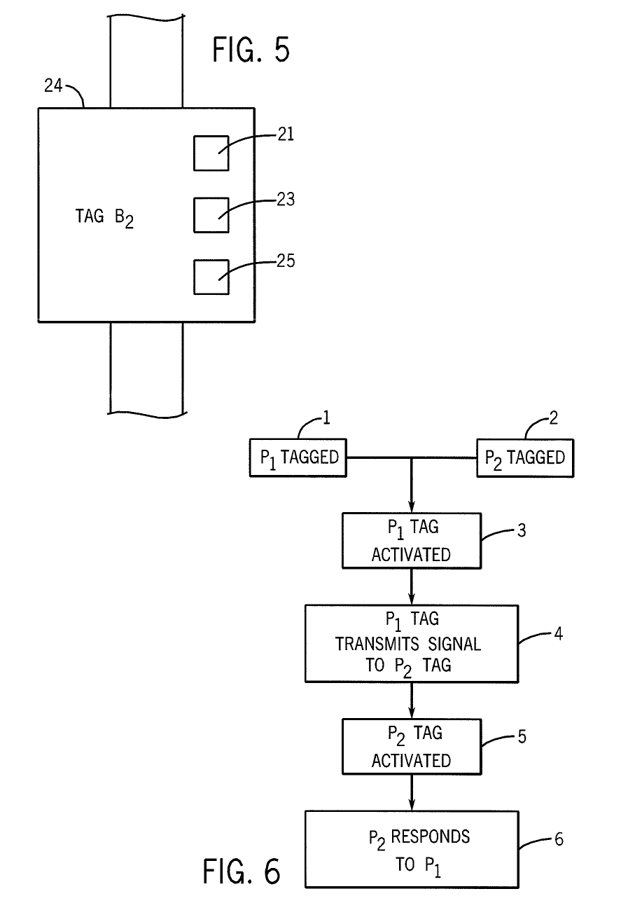

As shown in FIG. 5, the representative RFID tag TAG B₂ (24) worn by the second person (20) comprises at least three alternative modes for alerting that person of a situation that has been signaled by the first person (10) and transmitted via the RFID tag (12, 14) worn by that first person (10). The first mode is by a single light-emitting device or series of such lights (21). The second mode is by an audio signal or sound-emitting device (23). The third mode is by tactile vibration or a vibration-generating device (25). It is to be understood that one preferred embodiment of the present invention could use all of the three such modes (21, 23, 25), but is not so limited. In the system (100) of the present invention, it is also desirable to provide for some control means to increase or decrease the modality of the different signals. That is, it may be beneficial to control the volume of the sound-emitting device (23) and the sequencing of a series of lights (21) to better serve as an alert to the second person (20). For example, a series of lights (21) could comprise light-emitting diode (“LED”) technology and the series of lights could be arranged in a way that a “raceway” sequencing of the lights is created. The series of lights (21) could also be programmed to blink in a given sequence or in a way that the intensity of the lights is varied or variable. The series of lights (21) could also be configured of different colored lights or even preprogrammed such that certain colors of lights indicate the type of assistance that the first person (10) is requesting. For example, yellow lights could indicate a situation where assistance is required but the situation is not life-threatening. Red lights could indicate a more serious situation. The sound-emitting device (23) and the tactile vibration (25) could be similarly varied and pre-programmable in PLC of the RFID tag (24) as may be desired or required. This could provide customizable options for the system (100) in accordance with all of the foregoing. Such functionality would, however, require that the transmission tags (12, 14) include compatible signaling modalities. For example, the transmission tags (12, 14) could comprise a single push-button which, when held for a set amount of time allows the first person to signal the seriousness of the first person's condition. The transmission tags (12, 14) could also be pre-programmed such that a single push of a button indicates a first level of alert whereas a single push followed by a second push of a button indicates a more serious alert condition, and so on. It would also be within the scope of the present invention to provide multiple buttons to select from. However, the overall objective of the device of the present invention is to keep the device simple and easy to use, thus insuring that the transmission tags (12, 14) are properly and effectively used. Simplicity is key.

It should be also be understood that the RFID tags of the present invention include a power supply (not shown), such as a small direct current (DC) power supply, that would operate each of the transmitter and receiver devices mentioned above. Other pre-programmed variations could also be incorporated within the basic design of the present invention. However, it is also desirable to provide for each of the RFID tags of the present invention with circuitry (also not shown) built into the PLC that effectively places the devices in a “sleep” mode for energy conservation until the device is actuated. That is, the TAG A₁ worn by the first person (10) could be in a sleep mode until it is actuated to request assistance from the second person (20). Similarly, the TAG A₂ worn by the second person (20) could also be in a sleep mode until it receives a “wake-up” signal from TAG A₁ thereby alerting the second person (20) to come to the aid of the first person (10).

Referring now to FIG. 6, it illustrates a flow chart showing the methodology of the present invention. Specifically, the steps begin with tagging (1) the first person P₁ (10) and tagging (2) the second person P₂ (20). Upon activation (3) of the first person's tag TAG A₁, a signal is transmitted (4) to the second person's tag TAG A₂ which activates (5) that second person's tag TAG A₂ and alerts the second person (20) to the need of the first person (10). The second person (20) then responds (6) to the first person (20) as needed.

In view of the foregoing, it will be apparent that there has been provided a new, useful and non-obvious device, system and method that provides for a transmitter portion and a receiver portion. The transmitter portion can be worn and activated by a first person. The receiver is worn by a second person. Upon activation of the transmitter, the receiver portion, in turn, provides the second person with an alert via the receiver, which can be by a tactile vibration, a sound and a light, or any combination of such modalities. Each device is self-contained and carries an electrical energy source, such as a battery, and electrical circuitry that extends the useful life of the energy source. To insure sustained functionality, the devices can be used in a “sleep” mode and activated to a “use” mode. At all other times, the device portions would remain in the sleep mode, thereby preserving the electrical energy of the self-contained supply source.

The details of the invention having been disclosed in accordance with the foregoing, I claim:

1. An electronic assistance call device comprising:
a transmitter portion, the transmitter portion being electronically activated by a first user to transmit an RFID signal; and
a receiver portion, the receiver portion being in direct contact with and electronically activated by the transmitted RFID signal to indicate to a second user that the first person requires assistance.

2. The device of claim 1 wherein the electronically activated receiver portion further comprises an alert, the alert comprising at least one of a tactile vibration, a sound and a light.

3. The device of claim 2 wherein the alert vibration, sound and light are programmable to change the mode of vibration, sound and light of the alert.

4. The device of claim 1 wherein each of the transmitter portion and the receiver portion is a self-contained device that comprises an electrical energy source and electronic circuitry that extends the useful life of the energy source.

5. The device of claim 4 wherein each portion of the device can be used in a “sleep” mode and activated to a “use” mode to preserve the electrical energy of the energy source.

6. The device of claim 1 wherein each of the transmitter portion and the receiver portion is wearable about the wrist or the neck of the user.

7. The device of claim 1 wherein the transmitter portion and the receiver portion are synchronized at a specific wireless frequency.

8. An electronic assistance call system comprising:
a transmitter portion, the transmitter portion being electronically activated by a first person to transmit an RFID signal;
a receiver portion, the receiver portion being directly and electronically activated by a transmitted RFID signal to indicate to a second person that the first person requires assistance; and
an RFID signal that is transmitted by the transmitter portion directly to the receiver portion.

9. The system of claim 8 wherein the electronically activated receiver portion further comprises an alert, the alert comprising at least one of a tactile vibration, a sound and a light.

10. The system of claim 9 wherein the alert vibration, sound and light are programmable to change the mode of vibration, sound and light of the alert.

11. The system of claim 8 wherein each of the transmitter portion and the receiver portion is a self-contained device that comprises an electrical energy source and electronic circuitry that extends the useful life of the energy source.

12. The system of claim 11 wherein each portion of the device can be used in a “sleep” mode and activated to a “use” mode to preserve the electrical energy of the energy source.

13. The system of claim 8 wherein each of the transmitter portion and the receiver portion is wearable about the wrist or the neck of the user.

14. A method of providing electronic assistance from a first person to a second person comprising the steps of:
providing a transmitter portion to the first person;
electronically activating the transmitter portion by the first person;
generating an RFID signal from the transmitter;
providing a receiver portion to the second person;
directly transmitting the RFID signal to the receiver portion; and
electronically activating the receiver portion by the directly transmitted RFID signal to indicate to the second person that the first person requires assistance.

15. The method of claim 14 wherein the step of electronically activating the receiver portion further comprises the step of comprising an alert, the alert comprising at least one of a tactile vibration, a sound and a light.

16. The method of claim 15 wherein the alert vibration, sound and light are programmable to change the mode of vibration, sound and light of the alert.

17. The method of claim 14 wherein each of the transmitter portion and the receiver portion is a self-contained device that comprises an electrical energy source and electronic circuitry that extends the useful life of the energy source.

18. The method of claim 17 wherein each portion of the device can be used in a “sleep” mode and activated to a “use” mode to preserve the electrical energy of the energy source.

19. The method of claim 14 wherein each of the transmitter portion and the receiver portion is wearable about the wrist or the neck of the user.

20. The method of claim 14 wherein the transmitter portion and the receiver portion are synchronized at a specific wireless frequency.
